(19) United States
(12) Patent Application Publication
(10) Pub. No.: US 2012/0115447 A1
(43) Pub. Date: May 10, 2012

(54) SYSTEM AND METHOD FOR PROVIDING SAFETY CONTENT SERVICE

(75) Inventors: Byeong Cheol CHOI, Daejeon (KR); Jae Deok LIM, Daejeon (KR); Seung Wan HAN, Gwangju (KR)

(73) Assignee: Electronics and Telecommunications Research Institute, Daejeon (KR)

(21) Appl. No.: 13/285,079

(22) Filed: Oct. 31, 2011

(30) Foreign Application Priority Data
Nov. 4, 2010 (KR) 10-2010-0109383

(51) Int. Cl. H04W 4/00

(52) U.S. Cl. 455/414.1

(57) ABSTRACT

The present invention discloses a system and method for providing a safety content service. The system for providing the safety content service includes a first mobile terminal which extracts meta information of new content when the new content is generated, a server which receives the meta information of the new content from the first mobile terminal, analyzes whether the content is harmful based on a file name and a hash value of the content contained in the meta information, and outputs an analysis result, and a second mobile terminal which receives the analysis result from the server. According to the present invention, it is possible to provide a service which can prevent children and teenagers from being exposed to harmful contents through mobile terminals such as smart phones such that the children and teenagers can safely use multimedia content.

### CROSS-REFERENCE TO RELATED PATENT APPLICATION

This application claims the benefit of Korean Patent Application No. 10-2010-0109383, filed on Nov. 4, 2010, in the Korean Intellectual Property Office, the disclosure of which is incorporated herein in its entirety by reference.

### BACKGROUND OF THE INVENTION

1. Field of the Invention

The present invention relates to a safety content service and, more particularly, to a system and method for providing a safety content service.

2. Description of the Related Art

Recently, with the proliferation of smart phones, the use of multimedia content in mobile devices has been generalized. The multimedia content includes a number of contents harmful to children and teenagers, and thus it is necessary to prevent the children and teenagers from being exposed to harmful contents for a long time.

However, it is very difficult for the children and teenagers' parents or other guardians to monitor whether the children and teenagers watch the harmful contents through their mobile devices for 24 hours. Moreover, to prevent the mobile device from playing the content itself is unreasonable for several reasons.

Accordingly, it is necessary to provide a service framework for providing safety contents to the children and teenagers who use the multimedia contents (such as images and videos) through the mobile devices such as smart phones.

### SUMMARY OF THE INVENTION

The present invention has been made in an effort to solve the above-described problems associated with prior art, and an object of the present invention is to provide a system and method for providing a safety content service, which can prevent children and teenagers from being exposed to harmful contents through mobile terminals such as smart phones for a long time.

According to an aspect of the present invention to achieve the above object of the present invention, there is provided a system for providing a safety content service, the system comprising: a first mobile terminal which extracts meta information of new content when the new content is generated; a server which receives the meta information of the new content from the first mobile terminal, analyzes whether the content is harmful based on a file name and a hash value of the content contained in the meta information, and outputs an analysis result; and a second mobile terminal which receives the analysis result from the server.

According to another aspect of the present invention to achieve the above object of the present invention, there is provided a method for providing a safety content service in a system which comprises a first mobile terminal for a teenager, a server, and a second mobile terminal for a guardian, the method comprising: extracting, at the first mobile terminal, meta information of new content when the new content is generated and transmitting the meta information to the server; receiving, at the server, the meta information of the new content from the first mobile terminal; analyzing, at the server, whether the content is harmful based on a file name and a hash value of the content contained in the meta information and outputting an analysis result; and transmitting, at the server, the analysis result to the second mobile terminal.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram showing the configuration of a system for providing a safety content service in accordance with an exemplary embodiment of the present invention;

FIG. 2 is a diagram showing the configuration of a server in accordance with an exemplary embodiment of the present invention;

FIG. 3 is a message flowchart showing a process for real-time analysis in accordance with an exemplary embodiment of the present invention; and

FIG. 4 is a message flowchart showing a process for non-real-time analysis in accordance with an exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

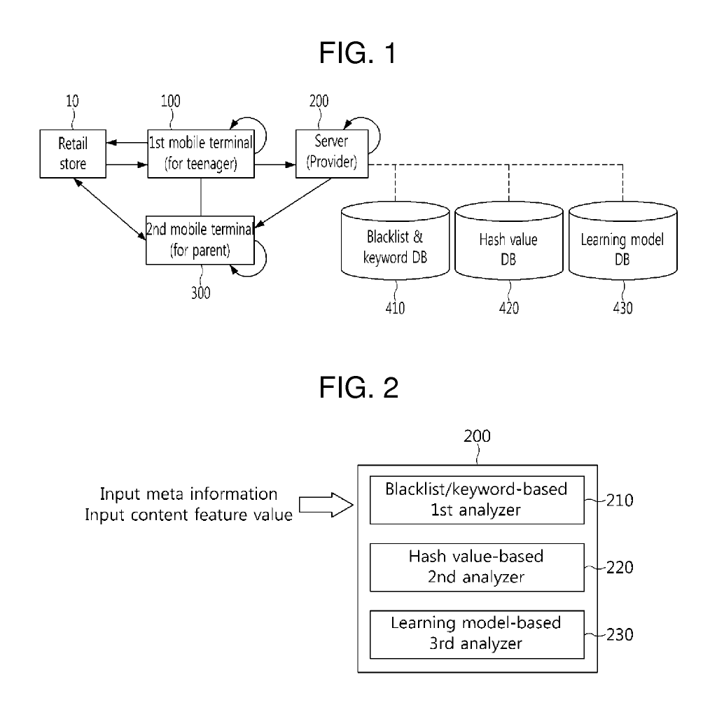

FIG. 1 is a diagram showing the configuration of a system for providing a safety content service in accordance with an exemplary embodiment of the present invention.

The system for providing the safety content service comprises a first mobile terminal 100, a server 200, and a second mobile terminal 300. The system for providing the safety content service may further comprise a retail store 10 that sells mobile terminals.

The first mobile terminal 100 is owned by a teenager and the second mobile terminal 300 is owned by a guardian of the teenager, for example, a parent of the teenager or other guardian.

A user of the first mobile terminal 100, i.e., the teenager, subscribes to a safety content service, and thereby a module for performing a method of the present invention, such as software may be installed in the first mobile terminal 100. Moreover, the first mobile terminal 100 and the second mobile terminal 300 have subscribed to the safety content service according to the present invention.

When new content is generated in the first mobile terminal 100, real-time analysis and non-real-time analysis are performed for the safety content service. In this case, the new content may be generated when it is stored or downloaded in the first mobile terminal 100.

The real-time analysis is performed fast enough to determine whether the content is harmful in real time and the non-real-time analysis requires a considerable time to determine whether the content is harmful. The real-time analysis and the non-real-time analysis are performed by cooperation between the first mobile terminal 100 and the server 200.

According to exemplary embodiments of the present invention, when the new content is generated, the real-time analysis is performed on the corresponding content immediately or within a short period of time. The non-real-time analysis uses a lot of processor resources of the mobile terminal 100 and a lot of resources of the server 200, and thus it is preferred that the non-real-time analysis be performed at a time when the first mobile terminal is rarely used. For example, the non-real-time analysis may be performed in a time zone when the first mobile terminal is rarely used such as at 1:00 AM to 5:00 AM. To this end, the time when the non-real-time analysis is performed may be predetermined in the first mobile terminal 100.

For the real-time analysis, when new content is generated, the first mobile terminal 100 extracts meta information of the new content and transmit the meta information to the server 200. Here, the meta information may contain a file name and a hash value of the new content.

When the meta information is received from the first mobile terminal 100, the server 200 determines whether the corresponding content is harmful based on the file name contained in the meta information.

To this end, the server 200 includes a blacklist and keyword database 410 and a hash value database 420. The blacklist and keyword database 410 stores harmful keywords in advance. Moreover, the hash value database 420 stores hash values of harmful contents in advance. The hash value represents a unique value for each file like a human fingerprint.

When the meta information of the new content is received from the first mobile terminal 100, the server 200 extracts the file name from the meta information. The server 200 compares the extracted file name with the keywords stored in the blacklist and keyword database 410. As a result of the comparison, if the file name matches one of the keywords stored in the blacklist and keyword database 410 or substantially matches one of the keywords, the server 200 determines that the corresponding new content is harmful.

If it is determined based on the blacklist and keyword database 410 that the corresponding new content is not harmful, the server 200 determines whether the content is harmful based on the hash value contained in the meta information. In detail, the server 200 compares the hash value of the new content with the hash values stored in advance in the hash value database 420. As a result of the comparison, if the hash value of the new content is the same as one of the hash values stored in the hash value database 420, the server 200 determines that the corresponding new content is harmful.

During the real-time analysis, the server 200 determines whether the new content is harmful based on the meta information provided from the first mobile terminal 100 and, if the corresponding content is harmful, transmits the analysis result to the second mobile terminal 300.

Moreover, for the non-real-time analysis, when new content is generated, the first mobile terminal 100 determines whether a condition for the non-real-time analysis is satisfied. The condition for the non-real-time analysis may be whether a predetermined time is reached. Accordingly, when the predetermined time is reached, for example, when it is 1:00 AM, the first mobile terminal 100 extracts a feature value of the new content. In detail, the first mobile terminal 100 extracts information on color, shape, texture, motion, and sound of the content (such as an image or video). This feature value is extracted based on the contents of the corresponding content. Since the technique for extracting the feature value from the content is known in the art, a detailed description thereof will be omitted. For example, the first mobile terminal 100 may extract a feature value of MPEG-7 visual descriptors from the new content. After extracting the feature value from the new content, the first mobile terminal 100 transmits the extracted feature value to the server 200.

When the feature value of the new content is received from the first mobile terminal 100, the server 200 determines whether the corresponding content is harmful using the feature value of the content with reference to a learning model database 430. For example, the learning model database 430 stores judgment models using a supervised learning engine (e.g., a support vector machine (SVM)).

During the non-real-time analysis, the server 200 determines whether the new content is harmful based on the feature value of the content provided from the first mobile terminal 100 and, if the corresponding content is harmful, transmits the analysis result to the second mobile terminal 300.

Next, the configuration and operation of the server 200 will be described with reference to FIG. 2.

FIG. 2 is a diagram showing the configuration of the server 200 in accordance with an exemplary embodiment of the present invention.

Referring to FIG. 2, the server 200 comprises a first analyzer 210, a second analyzer 220, and a third analyzer 230.

The first analyzer 210 compares the file name of the content transmitted from the first mobile terminal 100 with the blacklist or keywords stored in the blacklist and keyword database 410. As a result of the comparison, if the file name matches one of the blacklist or keywords stored in the blacklist and keyword database 410 or substantially matches one of the blacklist or keywords, the first analyzer 210 determines that the corresponding new content is harmful.

The second analyzer 220 compares the hash value of the content transmitted from the first mobile terminal 100 with the hash values stored in the hash value database 420. As a result of the comparison, if the hash value of the new content is the same as one of the hash values stored in the hash value database 420, the second analyzer 220 determines that the corresponding new content is harmful.

When the feature value of the new content is input, the third analyzer 230 determines whether the corresponding content is harmful using the feature value of the content with reference to the learning model database 430. The feature value of the content may be a feature value of MPEG-7 visual descriptors, for example. The third analyzer 230 determines whether the feature value of the content is harmful based on a judgment model using a supervised learning engine, for example. The analysis result output from the third analyzer 230 is expressed as a percentage (%) of how much the content is harmful. Therefore, if a result value indicating how much the feature value of the content is harmful exceeds a predetermined threshold value, the third analyzer 230 can determine that the corresponding content is harmful. The predetermined threshold value may be empirically determined.

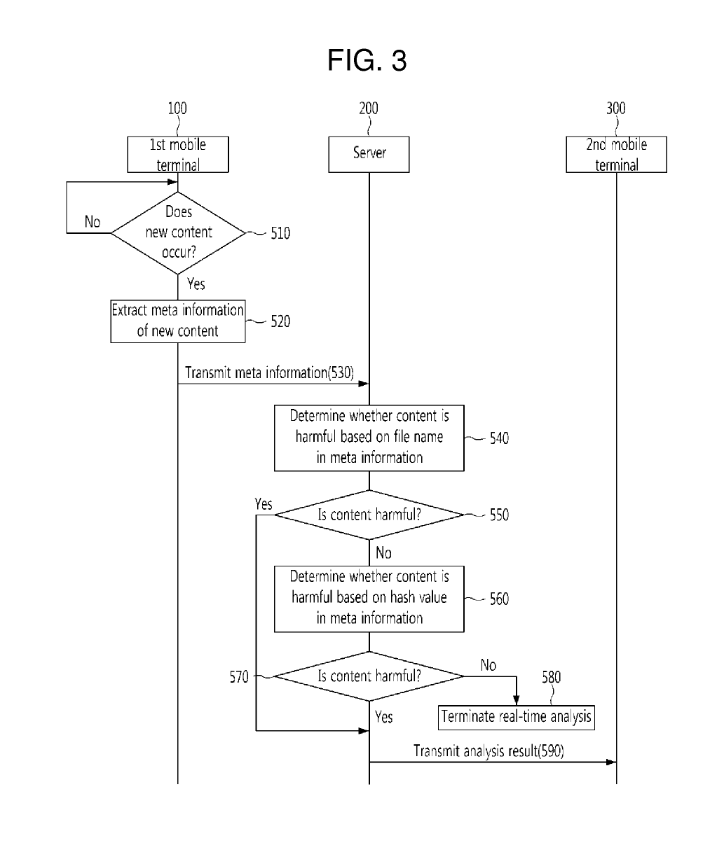

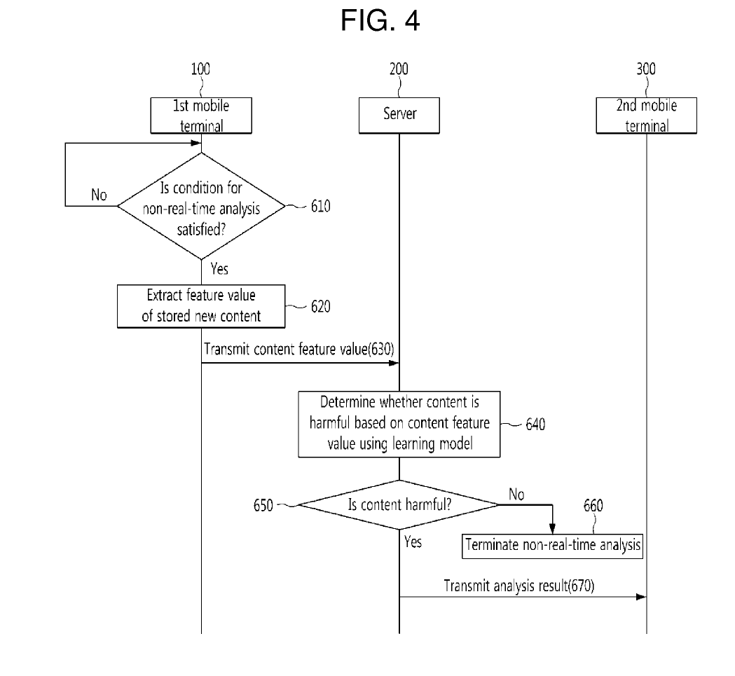

Next, a process for real-time analysis and a process for non-real-time analysis in accordance with the present invention will be described with reference to FIGS. 3 and 4.

FIG. 3 is a message flowchart showing a process for real-time analysis in accordance with an exemplary embodiment of the present invention.

Referring to FIG. 3, the first mobile terminal 100 determines whether new content is generated in step 510. The new content may be generated when it is stored or downloaded in the first mobile terminal 100. When the new content is generated, the first mobile terminal 100 extracts meta information of the new content in step 520 and transmits the meta information to the server 200 in step 530.

When the meta information is received from the first mobile terminal 100, the server 200 determines whether the corresponding content is harmful based on a file name contained in the meta information in step 540. In detail, the server 200 compares the file name with the keywords stored in the blacklist and keyword database 410 and, if the file name matches one of the keywords stored in the blacklist and keyword database 410 or substantially matches one of the keywords, determines that the corresponding new content is harmful in step 550.

Subsequently, if it is determined based on the blacklist and keyword database 410 that the corresponding new content is not harmful, the server 200 determines whether the content is harmful based on a hash value contained in the meta information in step 560. In detail, the server 200 compares the hash value of the new content with the hash values stored in advance in the hash value database 420. As a result of the comparison, if the hash value of the new content is the same as one of the hash values stored in the hash value database 420, the server 200 determines that the corresponding new content is harmful in step 570.

If the corresponding content is harmful, the server 200 transmits the analysis result to the second mobile terminal 300 in step 590. Here, the analysis result may be transmitted to the second mobile terminal 300 through a short message service (SMS) message or a multimedia message service (MMS) message.

FIG. 4 is a message flowchart showing a process for non-real-time analysis in accordance with an exemplary embodiment of the present invention.

Referring to FIG. 4, the first mobile terminal 100 determines whether a condition for the non-real-time analysis is satisfied in step 610. The condition for the non-real-time analysis may be whether a predetermined time is reached as mentioned above. Moreover, the non-real-time analysis may be performed periodically, and thus the condition may be whether a predetermined period is reached. The period may be once a week or once a day.

Accordingly, when the predetermined period is reached, the first mobile terminal 100 extracts a feature value of the new content in step 620. In detail, the first mobile terminal 100 extracts information on color, shape, texture, motion, and sound of the content (such as an image or video). After extracting the feature value from the new content, the first mobile terminal 100 transmits the feature value of the content to the server 200 in step 630.

When the feature value of the new content is received from the first mobile terminal 100, the server 200 determines whether the corresponding content is harmful using the feature value of the content with reference to the learning model database 430 in step 640. As mentioned above, when it is analyzed whether the content is harmful based on the learning model database, a result value indicating how much the content is harmful is output.

If the result value indicating how much the feature value of the content is harmful exceeds a predetermined threshold value, the server 200 can determine that the corresponding content is harmful in step 650.

If the corresponding content is harmful, the server 200 transmits the analysis result to the second mobile terminal 300 in step 670. The analysis result may be transmitted to the second mobile terminal 300 through an SMS message or an MMS message. For example, the analysis result may be as follows.
“There is a harmful content”
File name: xxx.avi
Reliability: 75%

Even if the content is not harmful, the analysis result may be transmitted to the second mobile terminal 300. In this case, the analysis result may represent “The safety content service is being used”.

As described above, according to the present invention, it is possible to provide a service which can prevent the children and teenagers from being exposed to harmful contents through mobile terminals such as smart phones such that the children and teenagers can safely use multimedia content.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A system for providing a safety content service, the system comprising:
a first mobile terminal which extracts meta information of new content when the new content is generated;
a server which receives the meta information of the new content from the first mobile terminal, analyzes whether the content is harmful based on a file name and a hash value of the content contained in the meta information, and outputs an analysis result; and
a second mobile terminal which receives the analysis result from the server.

2. The system of claim 1, wherein the first mobile terminal extracts a feature value of the content when a predetermined condition occurs and transmits the feature value to the server, and
wherein the server analyzes whether the content is harmful using a learning model when the feature value of the content is received and outputs an analysis result.

3. The system of claim 1, wherein the server comprises:
a blacklist and keyword database which stores harmful keywords; and
a hash value database which stores hash values of harmful contents.

4. The system of claim 3, wherein the server comprises a learning model database which stores learning models.

5. The system of claim 2, wherein the feature value comprises a feature value related to one of color, shape, texture, motion, and sound of the content.

6. The system of claim 2, wherein the predetermined condition is satisfied when a predetermined time is reached or when a predetermined period is reached.

7. The system of claim 1, wherein the analysis result is transmitted to the second mobile terminal through a short message service (SMS) message or a multimedia message service (MMS) message.

8. A method for providing a safety content service in a system which comprises a first mobile terminal for a teenager, a server, and a second mobile terminal for a guardian, the method comprising:
extracting, at the first mobile terminal, meta information of new content when the new content is generated and transmitting the meta information to the server;
receiving, at the server, the meta information of the new content from the first mobile terminal;
analyzing, at the server, whether the content is harmful based on a file name and a hash value of the content contained in the meta information and outputting an analysis result; and
transmitting, at the server, the analysis result to the second mobile terminal.

9. The method of claim 8, further comprising:
extracting, at the first mobile terminal, a feature value of the content when a predetermined condition occurs and transmitting the feature value to the server; and
analyzing, at the server, whether the content is harmful using a learning model when the feature value of the content is received and outputting an analysis result.

10. The method of claim 9, wherein the feature value comprises a feature value related to one of color, shape, texture, motion, and sound of the content.

11. The method of claim 9, wherein the predetermined condition is satisfied when a predetermined time is reached or when a predetermined period is reached.

12. The method of claim 8, wherein the analysis result is transmitted to the second mobile terminal through a short message service (SMS) message or a multimedia message service (MMS) message.
